(19) United States
(12) Patent Application Publication
(10) Pub. No.: US 2003/0005936 A1
(43) Pub. Date: Jan. 9, 2003

(54) Modified life mask

(76) Inventor: Ming-Mei Hsieh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/897,101

(22) Filed: Jul. 3, 2001

(51) Int. Cl. A62B 18/08; A62B 7/10; A62B 23/02; A62B 18/02

(52) U.S. Cl. 128/206.25; 128/205.27; 128/206.19

(57) ABSTRACT

The present invention proposes a modified life mask, which can protect the face, eyes, and hair of a user when hazards such as fire disasters happen. The modified life mask of the present invention comprises primarily a main body, a filtering device, and a contact part. The contact part is installed on the main body. The contact part is joined with the filtering device. The filtering device is fixedly installed on the main body. Thereby the contact part of the life mask can clamp the user's face so that the filtering device can stick tightly to the user's face to filter toxic gases effectively. The present invention also has the advantages of compact size, portability, easy operation, and convenient storing. Therefore, the modified life mask of the present invention can achieve best protection effect.

### FIELD OF THE INVENTION

The present invention relates to a modified life mask and, more particularly, to a life mask, which can filter various toxic gases in the fire site, and can discharge carbon dioxide breathed out from the user through a filtering device to prevent him from breathing in excess carbon dioxide. The proposed modified life mask can also prevent the user's hair and face from scathe, and can prevent the smoke from getting into the user's eyes.

### BACKGROUND OF THE INVENTION

Life equipment in prior art can protect the user's face through a mask to help the user escape from dangerous sites when hazards such as fire disasters happen. However, there are some problems of a life mask in prior art. For instance, it usually occupies much space, and can not be taken along conveniently. Also, filtering plates and pots need to be replaced constantly. Moreover, the operation is cumbersome, resulting in inconvenient use. Therefore, it has not been widely used for reducing casualties resulted from fire disasters.

Especially, a life mask in prior art can not achieve better protection effect when used. FIG. 5 shows a state of use of a life mask in prior art. As shown in this figure, a filtering device 3 of the life mask can not stick tightly to the mouth and nose of the user, and can not apply to people of various ages and habitus.

Therefore, although a life mask can mask the user's face, it can not discharge carbon dioxide breathed out and filter toxic gases pervasive in the fire site to let the user breathe air containing oxygen. Moreover, because there will be excess carbon dioxide in the life mask, the escaping time will be reduced, resulting in little escaping opportunity.

### SUMMARY AND OBJECTS OF THE PRESENT INVENTION

Accordingly, the primary object of the present invention is to provide a modified life mask, which can be unfolded to stick tightly to the face of the user when hazards such as fire disasters happen. A filtering device of the modified life mask can be positioned exactly on the mouth and nose of the user so as to filter various toxic gases pervasive in the fire site, and to discharge carbon dioxide to prevent the user from breathing excess carbon dioxide. The user can thus breathe filtered air directly. Moreover, the present invention can prevent the hair and face of the user from scathe, and can prevent the smoke from getting into the eyes so that the user can see escaping paths clearly. Therefore, the escaping opportunity of the user will be greatly increased.

Another object of the present invention is to provide a modified life mask, which can reflect thermal radiation and resist high temperature so as to keep the user in sobriety. The modified life mask of the present invention applies to various kinds of people, and its operation is simple. Moreover, the present invention does not occupy much space when not used, and can be taken along and stored conveniently.

The modified life mask of the present invention comprises primarily a main body, a filtering device, and a contact part. The contact part is installed on the main body. The contact part is joined with the filtering device. The filtering device is fixedly installed on the main body. Thereby the contact part of the life mask can clamp the user's face so that the filtering device can stick tightly to the user's face to filter toxic gases effectively.

The various objects and advantages of the present invention will be more readily understood from the following detailed description when read in conjunction with the appended drawings, in which:

### BRIEF DESCRIPTION OF DRAWINGS

FIG. 1 is an exploded perspective view of the present invention;

FIG. 2 is a partly assembly view of the present invention;

FIG. 3 is a perspective view showing a state of use of the present invention;

FIG. 4 is a side view of FIG. 3;

FIG. 5 is a side view of a life mask in prior art.

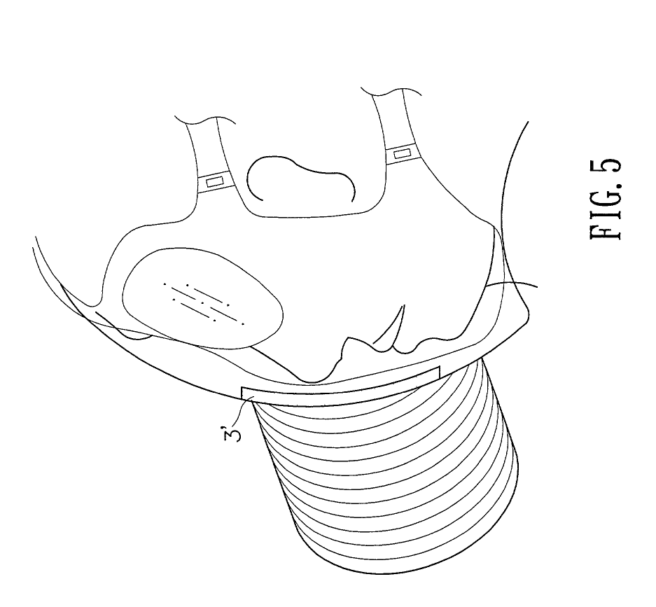

### DETAILED DESCRIPTION OF PREFERRED EMBODIMENT

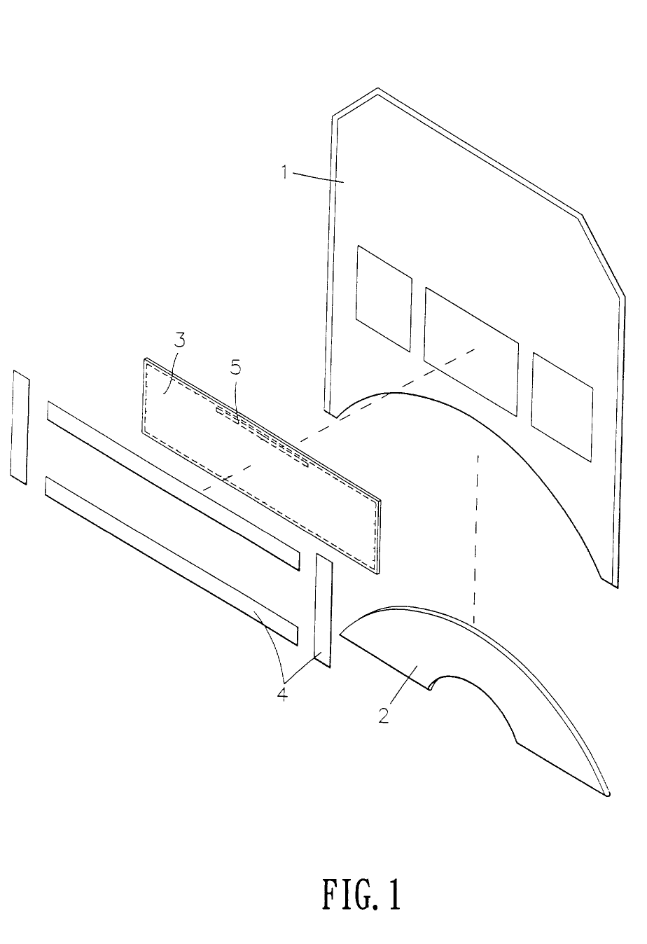

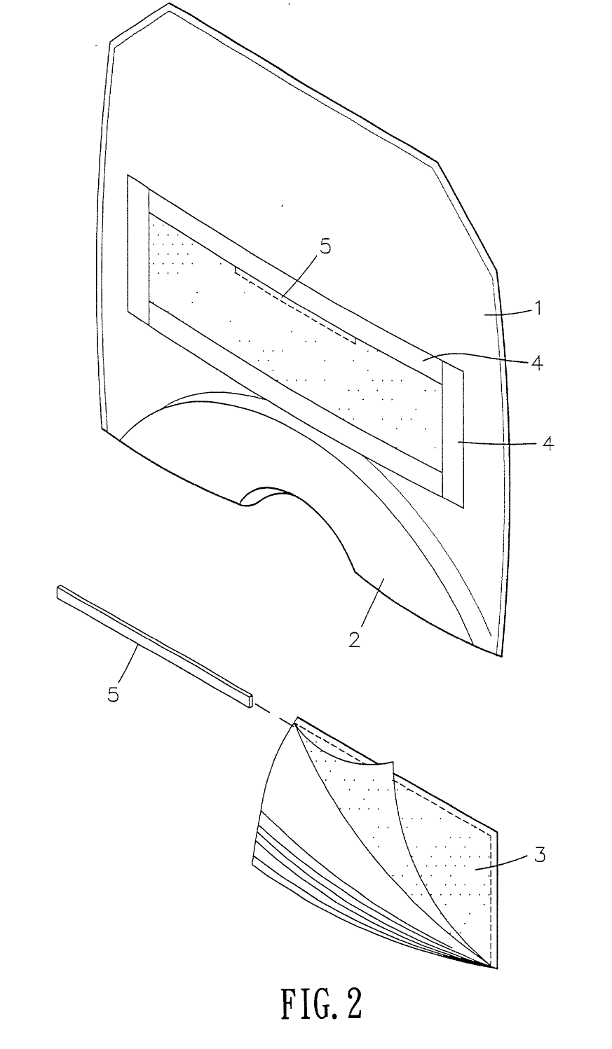

As shown in FIGS. 1 and 2, a modified life mask of the present invention comprises primarily a main body 1, a filtering device 3, and a contact part 5.

The main body 1 is a transparent casing, which has a good transparency and can resist temperature higher than 450° C. The main body 1 can protect the face, eyes, and hair of the user. A rubber element 2 is installed at the bottom end of the main body 1. The rubber element 2 is made of contractible material with good contractility and heat resistance.

The contact part 5 is installed on the main body 1. The contact part 5 is made of flexible material to position the main body 1 so that the main body 1 can stick tightly to the user's face. The contact part 5 joined with the filtering device 3 is fixedly installed on the main body 1. The contact part 5 is fixed via a ribbonlike positioning element 4.

The filtering device 3 is a multi-layer structure and is made of fire-resistant, heat-resistant material. The filtering device 3 can repeatedly filter and absorb toxic gases. The filtering device 3 also has the effect of catalyzing transformation. Moreover, the comfort of contacting with the user's face is also considered. Better protection effect of the life mask can thus be achieved.

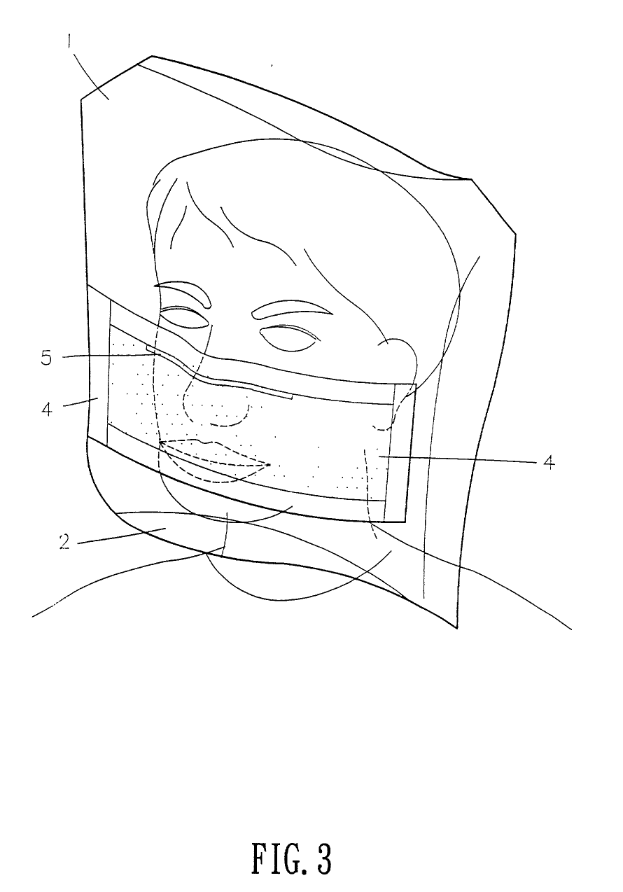

As shown in FIG. 3, when a fire disaster happens, the rubber element 2 at the bottom end of the main body 1 is unfolded. The life mask is then telescoped from the top of the user's head and adjusted so that the filtering device 3 is in front of the user's nose. Thereby the life mask can protect the user's face so as to increase the escaping time.

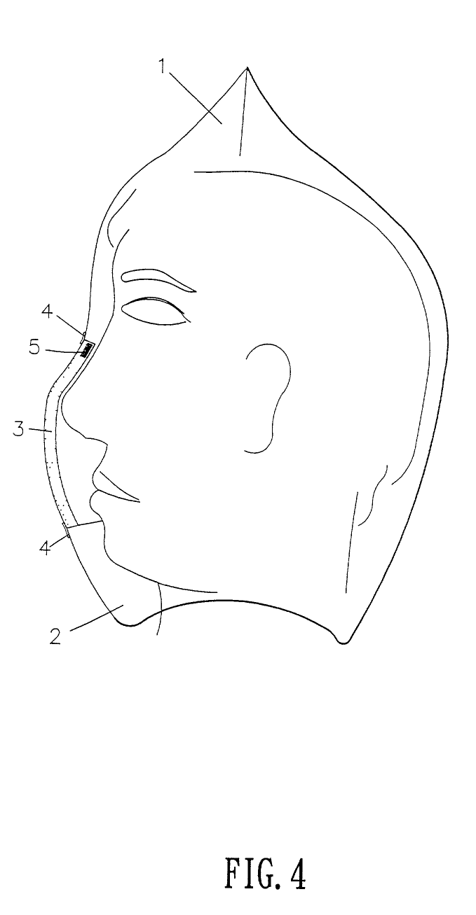

As shown in FIG. 4, when the life mask is used, because the contact part 5 is bent to clamp the user's face, the filtering device 3 will stick tightly to the mouth and nose of the user. Effects of filtering toxic gases and breathing in air containing oxygen can be enhanced.

Because the rubber element 2 can be unfolded, the life mask can be easily telescoped on the user's face. The present invention also has the advantages of occupying less space, easy operation, portability, and convenient storing so that it can be widely used.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A modified life mask comprising a main body, a filtering device, and a contact part, said contact part being installed on said main body, said contact part being joined with said filtering device, said filtering device being fixedly installed on said main body,
whereby said contact part of said modified life mask can clamp the user's face so that said filtering device can stick tightly to the user's face to effectively filter toxic gases and discharge carbon dioxide breathed out by the user.

2. The modified life mask of claim 1, wherein a rubber element is installed at the bottom end of said main body.

3. The modified life mask of claim 2, wherein said rubber element is made of contractible material.

4. The modified life mask of claim 1, wherein said filtering device is fixed via at least a positioning element.

5. The modified life mask of claim 4, wherein said positioning element is ribbonlike.

6. The modified life mask of claim 1, wherein said contact part is made of flexible material.
